(19) United States
(12) Patent Application Publication
(10) Pub. No.: US 2008/0301861 A1
(43) Pub. Date: Dec. 11, 2008

(54) THERMALLY PROTECTIVE SURVIVAL GARMENT

(76) Inventors: Robert F. Meistrell, Redondo Beach, CA (US); William T. Lafay, Redondo Beach, CA (US)

Correspondence Address: SCHNECK & SCHNECK, P.O. BOX 2-E, SAN JOSE, CA, 95109-0005, US

(21) Appl. No.: 12/135,799

(22) Filed: Jun. 9, 2008

Related U.S. Application Data
(60) Provisional application No. 60/929,043, filed on Jun. 8, 2007.

(51) Int. Cl. B63C 9/093; A62B 17/00

(52) U.S. Cl. 2/458; 441/103

(57) ABSTRACT

A thermally protective coveralls style suit having a plurality of separate water trapping regions between the suit and a user. The suit has a front slide fastener from crotch to neck with water entry retarding arm closures at the wrists and leg closures at ankles or thighs forming water trapping regions, leaving hands and feet free for swimming. Upper and lower chest straps cooperate forming water trapping regions by blocking pocket or water exchange between upper and lower torso regions. Permissive water entry at wrists, ankles or thighs, and neck or face, without circulation or exchange to surrounding water, allows separate pockets or thin film layers of water in the upper, lower, and central torso regions to insulate the body somewhat like a wetsuit where a single film provides insulation. An optional hood is provided to form another pocket or thin film layer without water circulation. Floatation pads assist buoyancy. A jacket embodiment is truncated at the lower chest strap.

### CROSS-REFERENCE TO RELATED APPLICATION

This application claims priority from provisional patent application Ser. No. 60/929,043, filed Jun. 8, 2007.

### TECHNICAL FIELD

The invention pertains to cold water survival equipment and, more particularly, to a thermally protective survival device for use by humans in water.

### BACKGROUND ART

Various types of personal floatation devices are known for use in emergency situations where a person is suddenly immersed in water. In particular, it is known that thermal protection is just as important as floatation since loss of body heat in cold water can lead to death in several minutes or sometimes in a few hours. One type of thermally protective device is a wetsuit style floatation device as shown in U.S. Pat. No. 5,022,878. In this patent, a wet suit adapted for fitting about at least a portion of a wearer and substantially conforming to at least the wearer's torso has a buoyant insert interposed between an outer layer and an inner layer of a vest portion of the wet suit. The buoyant insert extends in front of and behind the wearer's body. The wet suit style personal flotation device is constructed such that the wearer is supported in a slightly back from vertical position in water and such that the wearer can don the suit in less than about 60 seconds. While wet suits provide good thermal protection, they are difficult to put on unless one has a lot of practice.

Another type of survival suit is a loose fitting suit shown in U.S. Pat. No. 4,740,183. This life-saving suit, designed to help keep a person warm in cold water, is formed of sheet plastic and capable of being folded into a compact package. Arm and leg portions are sealed at their extremities, while the draw string exists at the neck region. This life-saving suit prevents constant exchange of cold water and prevents water from soaking the clothing and getting next to the skin whereby body heat is constantly removed. The suit permits the clothing being worn by the person to aid in trapping body heat and providing warmth from the outside chilling effects of the cold water.

Yet another type of survival suit is shown in U.S. Pat. No. 3,444,570. This patent shows a coverall-type of survival suit which provides insulation for the occupant of the suit permitting extended survival times in water, and in addition, provides means for maintaining the occupant dry. The suit is made of a material which provides good buoyancy to the occupant.

On the one hand, wet suit style devices have good buoyancy, good thermal protection and allow for free body movement, such as for swimming. On the other hand, coverall-type survival suits with sealed extremities allow for quick ingress, provide less thermal protection and less free body movement. Ideally, a survival suit should take less than one minute to don. Coast Guard regulations are implementing this ideal.

Free body movement is important for swimming. A characteristic overlooked by most prior art survival suits is a swimming capability.

An object of the invention was to provide a thermally protective survival device for use in water which has the thermal characteristics of a wet suit, but has the quick ingress qualities of a coverall-type survival suit and has a swimming capability.

### SUMMARY OF INVENTION

The invention is a loosely fitting coverall-style survival suit or jacket that features a plurality of water trapping regions within the device to provide thermal insulation in a cold water environment. The coveralls suit embodiment has a small amount of water permeability at the wrists, lower extremities, typically ankles or thighs, and neck due to primary straps but otherwise limiting the exchange of water through the central torso region by means of secondary straps across the central torso near the chest, all straps forming water trapping regions. Hands and feet are allowed to remain free for swimming.

Only thin layers or pockets of water in the water trapping regions come into contact with skin of a wearer, with water entry permitted at the wrists and lower extremities, i.e., ankles or thighs of a wearer, but water circulation substantially blocked at the central torso. The water trapping regions are each thermally insulative. If one water trapping region fails for some reason, another is still available and may provide some protection.

The survival suit is put on like coveralls, with a front slide type closure fastener, i.e., a zipper. Straps, bands, or cuffs at the wrists and ankles or thighs and a drawstring at the neck are primary limb end closures that must be tightened to limit water entry to allow formation of discrete pockets of water distributed as thin layers of water next to the body of a user.

The closures can be tightened when the wearer is in the water, but preferably before entry into cold water. The exposure of a wearer's hands, feet and face are needed to allow for swimming or maneuvering. Secondary straps are tightened in the vicinity of the chest to bring the suit tightly against the torso thereby limiting water circulation to a pocket in the central torso region and to help secure floatation pads in place. The secondary straps compensate water entry into the suit by blocking water circulation from the upper torso to the lower torso, thereby providing good thermal protection to the central torso. Hands and feet are free for swimming.

Alternate embodiments include a long pants version with ankle bands and tighteners and a short pants version where ankle bands are replaced by bands and tighteners at the thighs and a jacket model where lower bands are replaced by a waist band of double or triple is width of a chest band.

### DESCRIPTION OF THE FIGURES

FIG. 1 is a plan view of the thermally protective survival device of the present invention in use.

FIG. 2 is a front plan constructional view of the device of FIG. 1 with exploded views of closure features.

FIG. 3 is a front plan constructional view of the device of FIG. 1 with exploded views of floatation and water circulation limiting features.

FIG. 4 is a back plan constructional view of the device of FIG. 1.

FIG. 5 is a plan view showing alternate embodiments of the device of FIG. 1.

FIG. 6 is a plan view of an alternate embodiment of the device of FIG. 1 with leg portions truncated at thigh regions.

FIG. 7 is a plan view of an alternate embodiment of the device of FIG. 1 truncated at waist level thereby forming a jacket.

FIGS. 8-11 are operational views showing use of the apparatus of FIG. 1 from a storage box.

### DESCRIPTION OF INVENTION

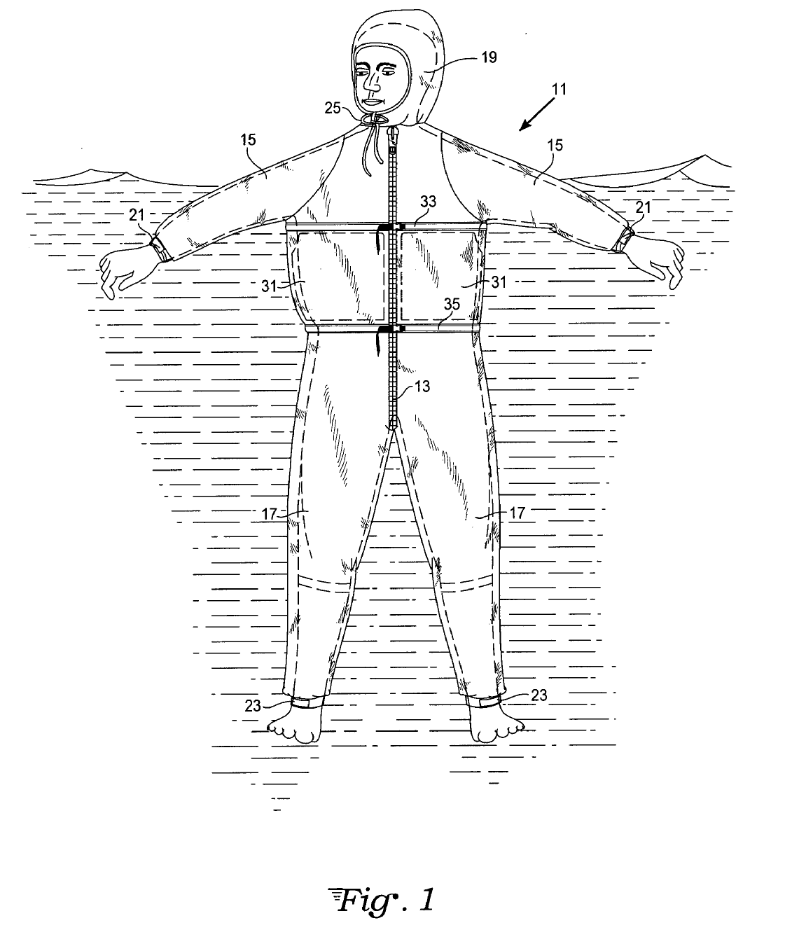

With reference to FIG. 1, a thermally protective floatation device 11 having a plurality of water trapping regions is shown. The device is a coverall garment with a zipper closure fastener 13 extending from crotch to neck. The coveralls may be made of selected water impervious materials such as Tyvek™, neoprene, rip-stop nylon, or water impervious polyester. The coveralls are similar to hazardous materials coveralls, fitting snugly over regular clothing but should not be too loose. The coveralls should be easy to don, allowing for free movement of arms and legs. Material that is slightly leaky to water, such as wetsuit material, is also acceptable and included within the definition of “water impervious”. Tyvek is a registered trademark of the Dupont Company for a non-woven spun olefin fiber sheet material. The material is difficult to tear and is water impervious. Tyvek coveralls are known to be one-piece jumpsuits sometimes worn by mechanics, printers, painters, or persons handling hazardous materials. Neoprene is synthetic rubber which is frequently used for fly fishing waders or for diving suits. Nylon is a thermal plastic polyamide fiber material. Rip-stop nylon is tightly woven nylon used for tents and sometimes for jackets. The material can be coated to be water impervious. Polyester is similar to nylon.

Arm portions 15 of the coverall suit terminate in arm closures 21, described below. Leg portions 17 terminate in leg closures 23, also described below. The suit incorporates foam floatation pads 31 which are two symmetric pads which cover the chest and extend below the arms. The floatation pads are typically one quarter inch to three-eighths inch thick. An upper chest strap 33 and a lower chest strap 35 are tightened at upper and lower regions of the central torso and may overlap the floatation pads. The two chest straps wrap completely around the body of a user and are tightened so that the loosely fitting coverall suit is pressed tightly against upper and lower portions of the chest. This feature limits water movement from the upper torso to the lower torso. Thus, the thermally protective suit contains several water trapping regions of which pockets of water next to clothing of a user, provides insulation to the user. A thin film layer or pocket of water is formed above the upper chest strap 33 by allowing leakage into the suit and out of the suit through the arm closures 21. The face or neck drawstring 25 allows formation of a pocket of water about the head. Another pocket of water exists between the upper and lower chest straps. While a little water can leak past these straps, water is generally confined in a layer or pocket to the central torso area. Water in this area is heated by the central torso and the heat is generally retained with assistance of the floatation pads. The leg portions 17 have some leakage through the leg closures 23, but water entering the leg regions and forming another pocket or layer does not pass to the upper torso regions because water is substantially blocked by the lower chest strap 35. The leg closures may be near the ankles or the coveralls have short pants, then near the thighs.

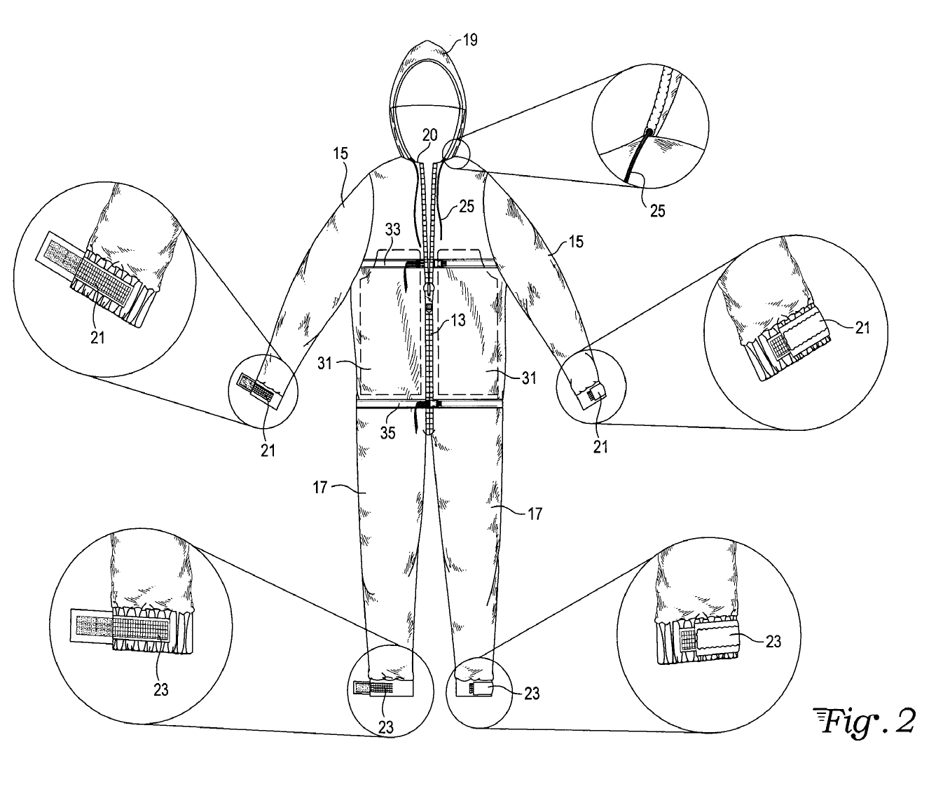

With reference to FIG. 2, details of arm closures 21 may be seen. These closures may be elastic bands with Velcro strip fasteners for tightening, or a similar arrangement such as Velcro bands used by cyclists to gather pant legs. Velcro, a trademark for fastening tape using hook and pile material, can tighten an elastic band and retard or limit water passage into and out of arm portions 15. A face or neck drawstring 25 can restrict water entry past hood 19 or the neck opening 20 so that a thin film of water or pockets in a water trapping region exists about the portions of the head, providing some insulation. In the situation where hood 19 is missing, the drawstring extends around the top of the garment at the neck opening and similarly retards water entry. The leg portions 17 have water retarded from in and out flow by the leg closures 23 of which, like the arm closures, may be elastic, Velcro or a combination of the two, with the latter preferred. The arm and leg closures leave hands and feet exposed for swimming or maneuvering.

In operation, thin films or pockets of water in water trapping regions may enter the upper portion of the protective suit above the upper chest strap 33 through the arm closures as well as the lower portion of the suit, below the lower chest strap 35. Water also is retarded by, but leaks past the upper and lower chest straps 33 and 35 so that a third film or pocket of water forms about the central chest cavity. However, there is no substantial amount of flow from the upper torso to the lower torso through the central torso region where the upper and lower chest straps 33 and 35 substantially block flow. The upper and lower chest straps also serve to retain floatation pads 31 in place. A single chest strap may be used instead of two chest straps, but upper and lower straps are more effective and preferred.

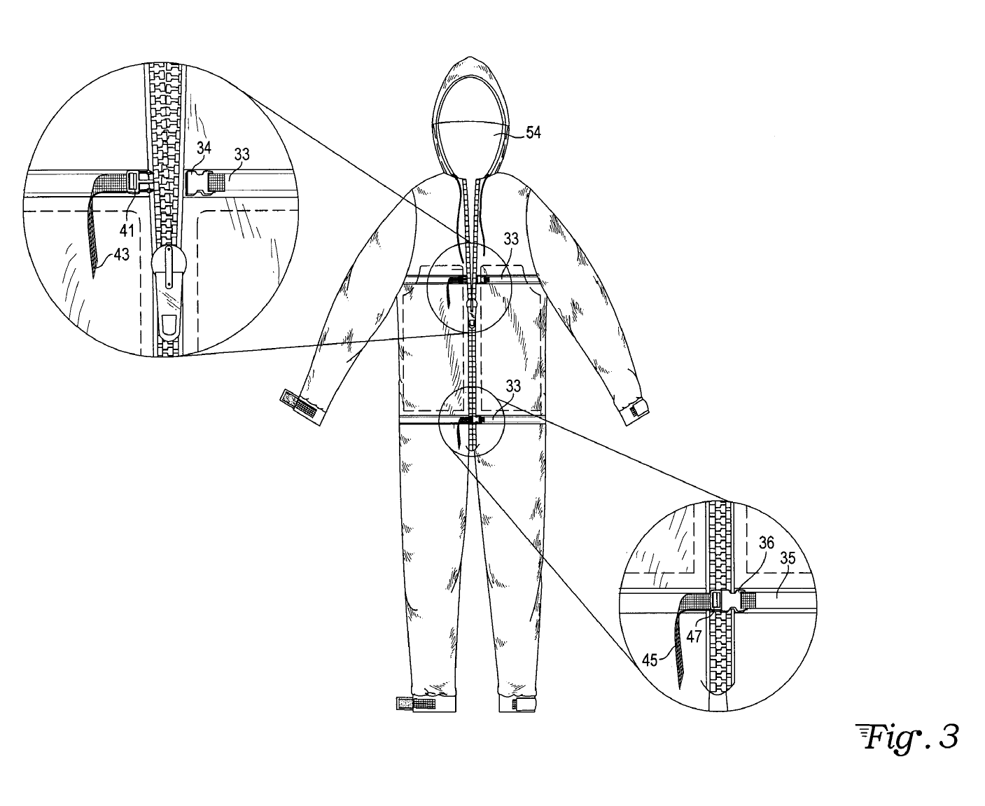

With reference to FIG. 3, the upper chest strap 33 is closed by a common snap-fit upper fastener 34 with a compression-fit web tightener member 41 that locks into place. The web tightener 41 allows the strap end 43 to be pulled, tightening the upper chest strap against the body. A similar fastener exists for the lower chest strap 35 having a lower fastener 36 that includes a compression fit web tightener member 47 that allows strap end 45 to be pulled, tightening the lower chest strap 35 against the torso. The lower chest strap may be as low as a conventional belt worn by a man.

With reference to FIG. 4, the backside of the protective suit 11 is seen to have the upper strap loops 51 retaining the upper chest strap 33 in place while the lower strap loops 53 retain the lower chest strap 35 in place. It is seen that the upper chest strap passes under the arm portions of 15 in the region of the arm pits. On the other hand, the lower chest strap 35 is at waist level. A floatation pad 54 associated with the hood is seen to be connected at the neck of the suit.

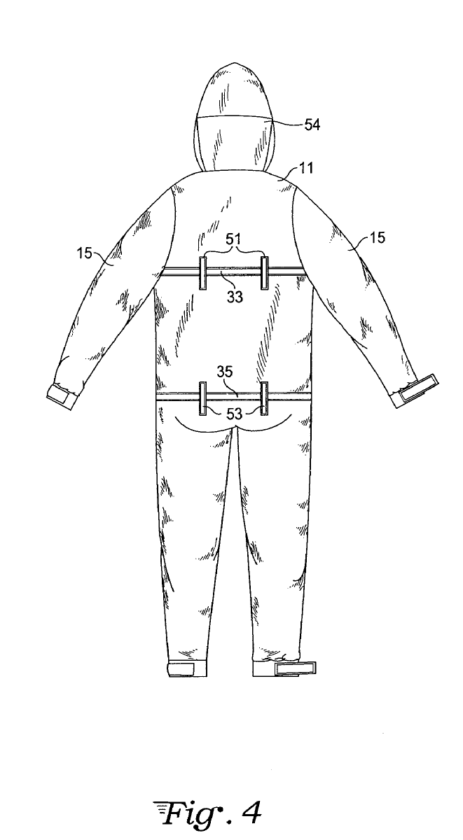

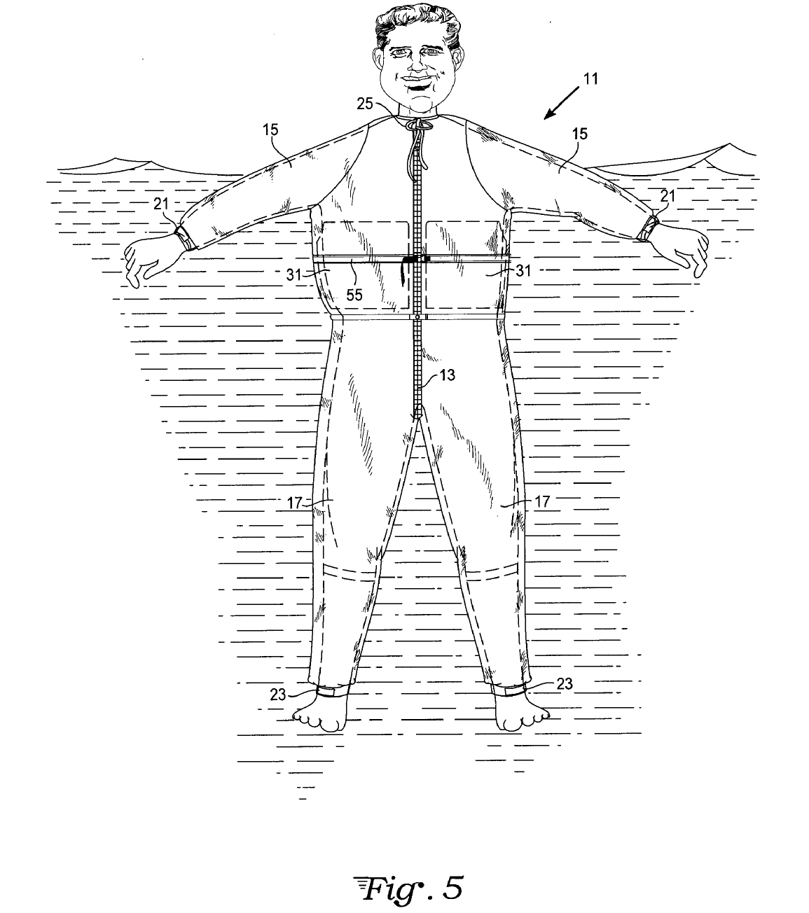

With reference to FIG. 5, the thermally protective coveralls protective suit 11 has many of the same features as the suit 11 shown in FIG. 1, except that there is no hood and only one belt 55 blocking water exchange from the upper torso region to the lower torso region. Belt 55 is snugly fastened over floatation pads 31 creating thin films of water at the upper and lower torso regions. Arm closures 21 and leg closures 23 operate as previously explained. The lack of a hood means that neck draw string 25 retards water entry into the upper torso region.

By allowing small amounts of water to enter the protective suit 11, the suit tends to behave like a wet suit, using several separate pockets or thin film layers of water in the upper torso, central torso, and lower torso regions to insulate the body against cold water outside of the suit. No water flows directly through the suit material, although small leaks are tolerable and some leakage is expected at the arm and leg closures as well as at the head and neck closure. Other water trapping regions may be formed beyond those disclosed above. For example, additional arm and leg straps could form further water trapping regions. A coverall protective suit is easy to put on in much less than one minute.

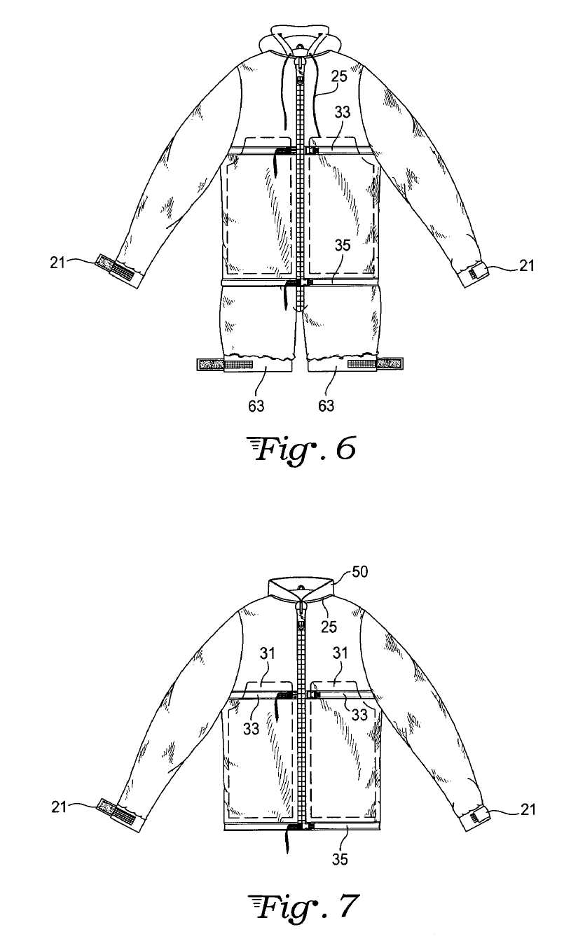

FIG. 6 shows a short pants model of the coveralls of the present invention with leg closures 63 being bands about the thighs with tighteners. Upper and lower chest straps 33 and 35, in combination with arm closures 21 and neck drawstring 25 all form pockets where water can leak in and accumulate in a static situation forming insulative regions. Note that the lower chest strap 35 with tighteners is at belt level. Floatation pads 31 are in the usual place.

FIG. 7 shows a jacket model of the invention, without pants. In the jacket model, the lower chest strap 35 is an elastic jacket band with a tightener truncating the suit. Upper chest strap 33 is in the usual place as are the arm closures 21. The arm closures and the upper chest strap 33 form a first water trapping pocket while the lower strap 35 and the upper chest strap 33 form a second water trapping pocket. A neck pouch 50 is provided where an optional hood is stored. Drawstring 25 is tightened about the neck.

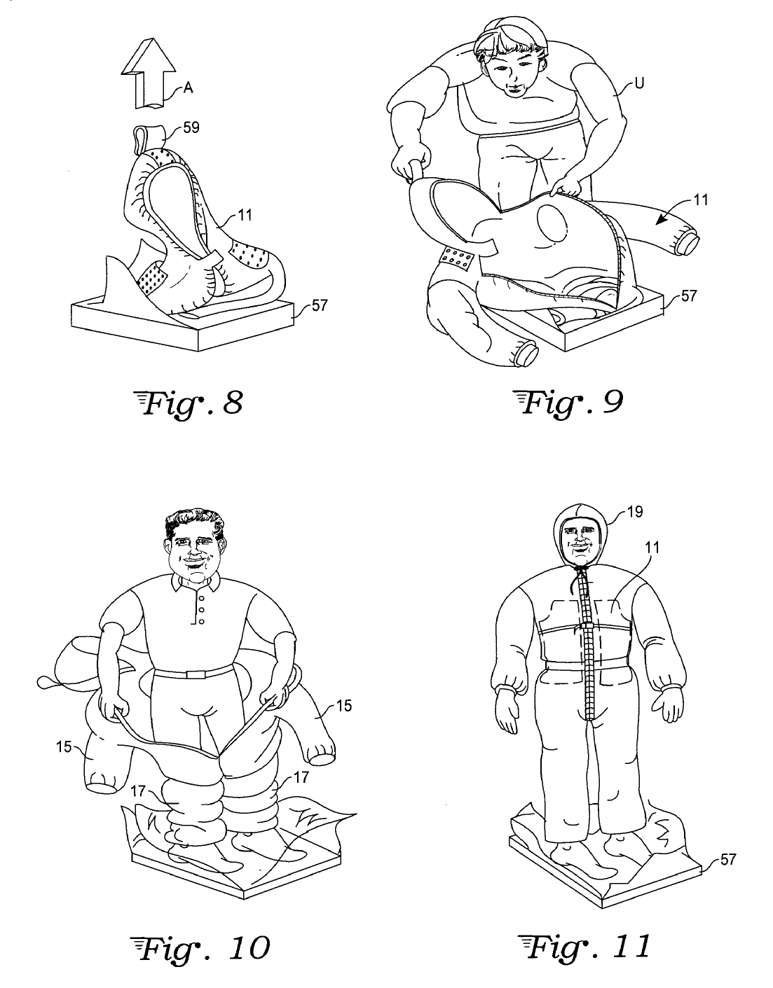

FIGS. 8-11 showing the donning of a thermally protective survival suit of the present invention. In FIG. 8 the upper portion of suit 11 is pulled from a flat pizza-size box 57 by means of a tab 59 in the direction indicated by arrow A. In FIG. 9, a user, U, unfolds suit 11 while lifting it out of the box and simultaneously opening the suit. In FIG. 10, the user has stepped into leg portions 17 and is about to enter arm portions 15. Note that feet are exposed. In FIG. 11, the user has donned the suit 11, including hood, and secured arm and leg closures, as well as a single strap across the central torso. Only one torso strap is shown for simplicity, but two would be preferred. The user will next step away from the flat box 57.

For ease of storage in flat box 57, legs were accordion-pleated, then rubber banded at the crotch to hold the pleats in a compressed state. The zipper is stored open and the upper portion of the garment is folded in a way so that leg holes are visible. A user steps into the leg holes and pulls up on the hood, snapping the rubber bands as the user pulls. Arms are inserted into sleeves and the zipper is pulled up. Bands, straps, and belts are tightened and checked.

Because Tyvek and nylon are so thin, a survival suit may be stored in a pizza-size box only one to one and one half inches thick. Thus, hundreds of survival suits may be stored in a closet, ideal for naval vessels.

What is claimed is:

1. A thermally protective survival suit to protect the torso but not hands, feet, or face of a swimming user comprising:
a water resistant coveralls garment having a plurality of separate water trapping regions between the garment and the body of a user, the garment having a neck or face drawstring, wrist bands and ankle or thigh bands and at least one chest bands, all bands having tighteners forming the water trapping regions.

2. The apparatus of claim 1 further comprising:
a hood attached to the coveralls garment with a drawstring forming another water trapping region about the head.

3. The apparatus of claim 1 wherein the at least one water trapping region comprises a pair of parallel, spaced apart belts forming a water trapping region therebetween.

4. A thermally protective survival jacket to protect the torso of a swimming user comprising:
a water resistant jacket garment having a plurality of water trapping regions between the garment and the body of a user, the garment having wrist bands, a chest band, a waist band, and a neck drawstring, all bands having tighteners forming the water trapping regions.

5. The apparatus of claim 4 further comprising:
a hood attached to the jacket garment for covering a user's head but not a user's face with the drawstring forming another water trapping region about the head.

6. A thermally protective survival suit to protect the torso but not hands, feet, or face of a swimming user comprising:
a water resistant coveralls garment with upper and lower regions, a front side and a back side and having a front side water impervious slide-type closure fastener extending from the lower region to the upper region and with face, hand, and lower extremity openings and with snugly fitting wrist bands, lower extremity bands, and a drawstring at an upper region near the face of a wearer, all adapted to retard permissive entry of water into the coveralls garment thereby forming a wetsuit;
floatation foam disposed in the upper region affixed to the coveralls garment; and
at least one belt near the floatation foam girding the coverall garment retarding water movement between upper and lower regions, thereby forming a plurality of water trapping regions within the coveralls garment for thermal insulation.

7. The apparatus of claim 6 further wherein the at least one belt near the floatation foam comprises a pair of belts girding the coveralls in parallel, spaced apart relation.

8. The apparatus of claim 6 wherein the coveralls garment is made of Tyvek.

9. The apparatus of claim 6 wherein the coveralls garment is made of nylon.

10. The apparatus of claim 6 wherein the coveralls garment is made of neoprene.

11. The apparatus of claim 6 wherein the coveralls garment is made of polyester.

12. The apparatus of claim 6 wherein the wrist bands are elastic bands with tighteners.

13. The apparatus of claim 6 wherein the ankle bands are elastic bands with tighteners.

14. The apparatus of claim 12 wherein the tighteners are Velcro tighteners.

15. The apparatus of claim 13 wherein the tighteners are elastic bands with Velcro tighteners.

16. The apparatus of claim 6 wherein the at least one belt has a pull-type tightener.

17. The apparatus of claim 6 wherein the floatation foam comprises a pair of symmetric panels affixed to the front side within the coveralls garment.

18. The apparatus of claim 6 wherein the coveralls garment further comprises a hood attached to the coveralls garment with the drawstring forming another water trapping region.

19. The apparatus of claim 1 foldable into a box having dimensions of pizza-style box.

20. The apparatus of claim 4 foldable into a box having dimensions of a pizza-style box.
